(19) United States
(12) Patent Application Publication
(10) Pub. No.: US 2024/0126672 A1
(43) Pub. Date: Apr. 18, 2024

(54) HCI WORKLOAD SIMULATION

(71) Applicant: Dell Products L.P., Round Rock, TX (US)

(72) Inventors: Hongwei YUE, Shanghai (CN); Shunhua XIE, Shanghai (CN)

(73) Assignee: Dell Products L.P., Round Rock, TX (US)

(21) Appl. No.: 17/980,394

(22) Filed: Nov. 3, 2022

(30) Foreign Application Priority Data
Oct. 14, 2022 (CN) 202211264701.7

(51) Int. Cl. G06F 11/34; G06F 11/30; G06K 9/62

(52) U.S. Cl. CPC G06F 11/3428; G06F 11/3006; G06K 9/6256

(57) ABSTRACT

An information handling system may include at least one processor and a memory. The information handling system may be configured to: receive telemetry information regarding a target workload; receive configuration data regarding a computing cluster that is to execute a simulation of the target workload; train a workload artificial intelligence (AI) model based on the telemetry information and the configuration data to create the simulation of the target workload; generate a benchmarking configuration file based on the workload AI model; and deploy the benchmarking configuration file to the computing cluster for execution.

### TECHNICAL FIELD

The present disclosure relates in general to information handling systems, and more particularly to techniques for simulations of workloads in information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

Customer environments and workloads can vary significantly from one customer to another (e.g., the network configuration; storage usage; and I/O patterns, such as IOPS, I/O rate, read-write ratio, etc.). It is useful to be able to simulate a customer's environment and workload during testing of an HCI system, but the variability among environments and workloads limits the effectiveness of existing methods. Accordingly, embodiments of this disclosure provide improved techniques.

Some embodiments of this disclosure may employ artificial intelligence (AI) techniques such as machine learning, deep learning, natural language processing (NLP), etc. Generally speaking, machine learning encompasses a branch of data science that emphasizes methods for enabling information handling systems to construct analytic models that use algorithms that learn interactively from data. It is noted that, although disclosed subject matter may be illustrated and/or described in the context of a particular AI paradigm, such a system, method, architecture, or application is not limited to those particular techniques and may encompass one or more other AI solutions.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with workload simulation in information handling systems may be reduced or eliminated.

In accordance with embodiments of the present disclosure, an information handling system may include at least one processor and a memory. The information handling system may be configured to: receive telemetry information regarding a target workload; receive configuration data regarding a computing cluster that is to execute a simulation of the target workload; train a workload artificial intelligence (AI) model based on the telemetry information and the configuration data to create the simulation of the target workload; generate a benchmarking configuration file based on the workload AI model; and deploy the benchmarking configuration file to the computing cluster for execution.

In accordance with these and other embodiments of the present disclosure, a method may include an information handling system receiving telemetry information regarding a target workload; the information handling system receiving configuration data regarding a computing cluster that is to execute a simulation of the target workload; the information handling system training a workload artificial intelligence (AI) model based on the telemetry information and the configuration data to create the simulation of the target workload; the information handling system generating a benchmarking configuration file based on the workload AI model; and the information handling system deploying the benchmarking configuration file to the computing cluster for execution.

In accordance with these and other embodiments of the present disclosure, an article of manufacture may include a non-transitory, computer-readable medium having computer-executable instructions thereon that are executable by a processor of an information handling system for: receiving telemetry information regarding a target workload; receiving configuration data regarding a computing cluster that is to execute a simulation of the target workload; training a workload artificial intelligence (AI) model based on the telemetry information and the configuration data to create the simulation of the target workload; generating a benchmarking configuration file based on the workload AI model; and deploying the benchmarking configuration file to the computing cluster for execution.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of an example architecture, in accordance with embodiments of the present disclosure;

FIG. 3 illustrates an example method, in accordance with embodiments of the present disclosure; and

FIG. 4 illustrates an example method, in accordance with embodiments of the present disclosure.

### DETAILED DESCRIPTION

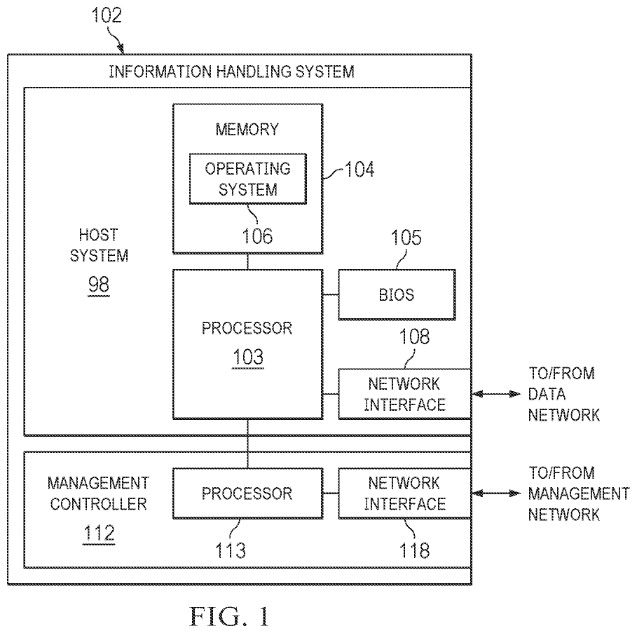

Preferred embodiments and their advantages are best understood by reference to FIGS. 1 through 4, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure provide improvements in the field of simulating a customer's environment and workload. Information regarding a customer's workload data and system configuration may be collected via telemetry accessed by an HCI cloud intelligence system, and embodiments may employ deep learning techniques to create a workload AI model based on the collected information.

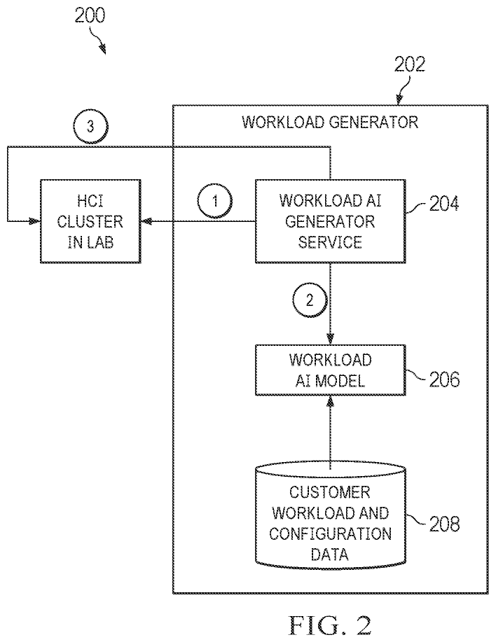

Turning now to FIG. 2, an example architecture 200 is shown for performing such a simulation of a workload in an HCI system. Architecture 200 uses AI techniques in this embodiment. In some embodiments, architecture 200 may run on the HCI system in question (e.g., implemented as one or more microservices). In other embodiments, architecture 200 may run on another information handling system.

At a high level, architecture 200 operates by having a workload generator 202 perform workload simulations on a test HCI cluster in the lab. Workload generator 202 may be configured to invoke an API of workload AI generator service 204. Workload AI generator service 204 may fetch configuration information from the lab HCI cluster at step 1. At step 2, workload AI generator service 204 may invoke a workload AI model 206 to supply a recommended workload profile based on the lab cluster's configuration, and further based on the real customer's workload and configuration data 208. Accordingly, the generated workload may be very similar to the customer's actual workload, taking into account the configuration of the lab HCI cluster on which it is to be executed.

At step 3, the workload AI generator service 204 may launch a benchmarking tool such as HCIBENCH to generate, deploy, and benchmark the AI-generated workload on the lab HCI cluster.

For the workload AI training dataset, various information regarding the customer's workload may be leveraged. For example, the customer's typical number of VMs per host, I/O patterns, read-write ratios, and hardware configuration information such as CPU models and speeds, memory, storage type and size, etc. may all be incorporated.

According to different key features in the collected data, several different profiles may be generated. For example, each profile may have different numbers of VMs, different numbers of data disks, different data disk sizes, different numbers of CPUs, different utilization rates of CPU and memory for each VM, different I/O patterns, etc. In some embodiments, the generated profiles may include the information that is needed to create configuration files for the benchmarking tool, as discussed in more detail below.

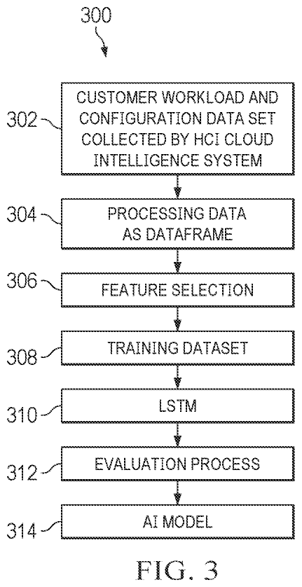

Turning now to FIG. 3, an example method 300 is shown for creating a workload AI model, according to some embodiments.

At step 302, a customer workload and configuration data set is collected by an HCI cloud intelligence system. At step 304, the collected data is processed (e.g., as a DataFrame using a data analysis tool such as Pandas). At step 306, feature selection is performed on the data (e.g., using an AI tool such as Keras and/or Tensorflow).

At step 308, a training dataset is generated (e.g., again using an AI tool such as Keras and/or Tensorflow). At step 310, one or more machine learning algorithms such as long short-term memory (LSTM) are applied to the training dataset. At step 312, the results are evaluated, and the AI model is generated at step 314.

Once the workload AI model is built, the workload AI model and engine may be wrapped into an AI microservice with a REST API exposed. This API may then be integrated into other performance testing/monitoring solutions.

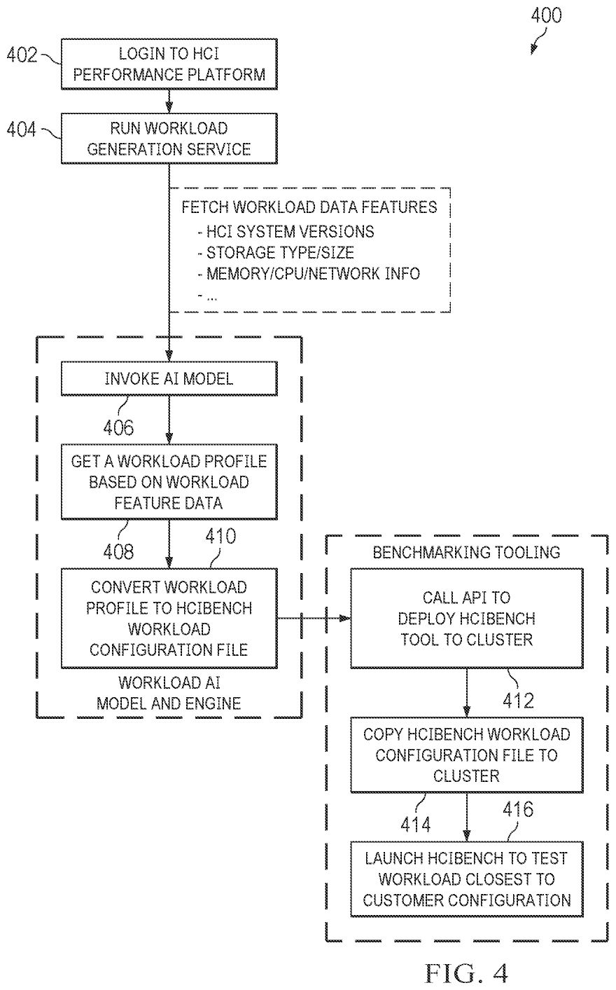

Turning now to FIG. 4, an example method 400 is shown for performing an HCI workload simulation of a customer's target system, according to some embodiments.

At steps 402 and 404, a user may login to an HCI performance platform and run the workload generation service. The workload generation service may generate a workload AI model based on a target HCI system's various parameters as shown, which may be fetched via an HCI cloud intelligence system.

Steps 406, 408, and 410 illustrate the operation of the workload AI model and engine, which result in a configuration file usable by a benchmarking tool such as HCIBENCH to run and benchmark a simulated workload. Steps 412, 414, and 416 illustrate the operation of the benchmarking tooling, which loads the simulated workload from the HCIBENCH configuration file, deploys it to an HCI cluster, and tests the workload.

One of ordinary skill in the art with the benefit of this disclosure will understand that the preferred initialization point for the methods depicted in FIGS. 3-4 and the order of the steps comprising those methods may depend on the implementation chosen. In these and other embodiments, the methods may be implemented as hardware, firmware, software, applications, functions, libraries, or other instructions. Further, although FIGS. 3-4 disclose a particular number of steps to be taken with respect to the disclosed methods, the methods may be executed with greater or fewer steps than depicted. The methods may be implemented using any of the various components disclosed herein (such as the components of FIG. 1), and/or any other system operable to implement the methods.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to:
receive telemetry information regarding a target workload;
receive configuration data regarding a computing cluster that is to execute a simulation of the target workload;
train a workload artificial intelligence (AI) model based on the telemetry information and the configuration data to create the simulation of the target workload;
generate a benchmarking configuration file based on the workload AI model; and
deploy the benchmarking configuration file to the computing cluster for execution.

2. The information handling system of claim 1, wherein the computing cluster is a hyper-converged infrastructure (HCI) cluster.

3. The information handling system of claim 1, wherein the AI model is a long short-term memory (LSTM) model.

4. The information handling system of claim 1, wherein the workload AI model is implemented via a microservice architecture.

5. The information handling system of claim 1, wherein the telemetry information is received from a cloud intelligence system.

6. The information handling system of claim 1, wherein the telemetry information further includes information regarding a target information handling system configured to execute the target workload.

7. A method comprising:
an information handling system receiving telemetry information regarding a target workload;
the information handling system receiving configuration data regarding a computing cluster that is to execute a simulation of the target workload;
the information handling system training a workload artificial intelligence (AI) model based on the telemetry information and the configuration data to create the simulation of the target workload;
the information handling system generating a benchmarking configuration file based on the workload AI model; and
the information handling system deploying the benchmarking configuration file to the computing cluster for execution.

8. The method of claim 7, wherein the computing cluster is a hyper-converged infrastructure (HCI) cluster.

9. The method of claim 7, wherein the AI model is a long short-term memory (LSTM) model.

10. The method of claim 7, wherein the workload AI model is implemented via a microservice architecture.

11. The method of claim 7, wherein the telemetry information is received from a cloud intelligence system.

12. The method of claim 7, wherein the telemetry information further includes information regarding a target information handling system configured to execute the target workload.

13. An article of manufacture comprising a non-transitory, computer-readable medium having computer-executable instructions thereon that are executable by a processor of an information handling system for:
receiving telemetry information regarding a target workload;
receiving configuration data regarding a computing cluster that is to execute a simulation of the target workload;
training a workload artificial intelligence (AI) model based on the telemetry information and the configuration data to create the simulation of the target workload;
generating a benchmarking configuration file based on the workload AI model; and
deploying the benchmarking configuration file to the computing cluster for execution.

14. The article of claim 13, wherein the computing cluster is a hyper-converged infrastructure (HCI) cluster.

15. The article of claim 13, wherein the AI model is a long short-term memory (LSTM) model.

16. The article of claim 13, wherein the workload AI model is implemented via a microservice architecture.

17. The article of claim 13, wherein the telemetry information is received from a cloud intelligence system.

18. The article of claim 13, wherein the telemetry information further includes information regarding a target information handling system configured to execute the target workload.
